(19) United States
(12) Patent Application Publication
(10) Pub. No.: US 2013/0315636 A1
(43) Pub. Date: Nov. 28, 2013

(54) DEVELOPMENT DEVICE AND IMAGE FORMING APPARATUS INCORPORATING SAME

(71) Applicants: Akihiro TAKAYAMA, Kanagawa (JP); Susumu TATEYAMA, Ibaraki (JP); Yuji SUZUKI, Tokyo (JP); Tatsuya KUBO, Kanagawa (JP); Hiroyuki UENISHI, Kanagawa (JP); Kentaro NODERA, Kanagawa (JP); Shinnosuke KOSHIZUKA, Kanagawa (JP)

(72) Inventors: Akihiro TAKAYAMA, Kanagawa (JP); Susumu TATEYAMA, Ibaraki (JP); Yuji SUZUKI, Tokyo (JP); Tatsuya KUBO, Kanagawa (JP); Hiroyuki UENISHI, Kanagawa (JP); Kentaro NODERA, Kanagawa (JP); Shinnosuke KOSHIZUKA, Kanagawa (JP)

(73) Assignee: RICOH COMPANY, LTD., Tokyo (JP)

(21) Appl. No.: 13/896,660

(22) Filed: May 17, 2013

(30) Foreign Application Priority Data
May 25, 2012 (JP) 2012-119293

(51) Int. Cl. G03G 15/09

(52) U.S. Cl. CPC G03G 15/0812
USPC 399/272

(57) ABSTRACT

A development device includes a developer bearer, a developer regulator to adjust an amount of developer on the developer bearer, a supply compartment adjacent to the developer bearer across a side wall formed monolithic with the development casing using an identical material, a developer supply member to transport developer in the supply compartment in an axial direction, and a channel forming member having higher rigidity than that of the side wall. The channel forming member defines, with the side wall, a supply route extending over an entire development range, through which developer moves from the supply compartment to the developer bearer, and defines, with an inner wall of the development casing, a collecting route through which developer blocked by the developer regulator is collected in the supply compartment. Both axial end portions of the channel forming member are supported by the development casing.

### CROSS-REFERENCE TO RELATED APPLICATION

This patent application is based on and claims priority pursuant to 35 U.S.C. §119 to Japanese Patent Application No. 2012-119293, filed on May 25, 2012, in the Japan Patent Office, the entire disclosure of which is hereby incorporated by reference herein.

### BACKGROUND OF THE INVENTION

1. Field of the Invention

The present invention generally relates to a development device that employs a developer bearer to transport by rotation developer carried thereon, and an image forming apparatus, such as a copier, a facsimile machine, a printer, or multifunction machine capable of at least two of these functions, that includes the development device.

2. Description of the Background Art

In image forming apparatuses such as electrophotographic copiers, electrostatic recording devises, or magnetic recording devices, development devices using two-component developer including toner and magnetic carrier (i.e., two-component type development devices) are widely used for developing electrostatic latent images formed on latent image bearers. Such two-component development devices typically include a developer bearer rotatable relative to a casing of the development device (hereinafter “development casing”) and a developer regulator disposed across a gap (regulation gap) from the developer bearer.

Developer (i.e., developer particles) is magnetically carried on the surface of the developer bearer and caused to stand on end thereon in a development range where the developer bearer faces a latent image bearer. In the development range, the developer standing on end forms a magnetic brush and slidingly contacts the surface of the latent image bearer. Then, toner in the developer adheres to the electrostatic latent image formed thereon, thus developing it into a toner image (development process).

Magnetic force on the surface of the developer bearer is generated by a magnetic field generator having multiple magnetic poles, provided inside the developer bearer. The magnetic field generator may be constructed with multiple magnets. The magnetic field generator includes a pump-up pole or attraction pole for generating magnetic force for attracting developer to the surface of the developer bearer, a regulation pole for causing developer to stand on end in the regulation gap, and a development pole for causing developer to stand on end on the developer bearer in the development range.

For example, JP-2008-256813-A proposes a two-component development device in which a developer supply compartment and a developer collecting compartment are formed by the development casing and interior wall therein, and conveyance screws (i.e., developer supply screw and developer collecting screw) are provided therein. The developer supply screw supplies the developer from the developer supply compartment to the developer bearer while transporting the developer in the axial direction of the developer bearer. The developer supply compartment is positioned adjacent to the developer bearer, and a side wall of the developer supply compartment or a partition divides, at least partially, the developer supply compartment from the portion where the developer bearer is provided.

The developer in the developer supply compartment overstrides the side wall and is carried on the surface of the developer bearer due to the pump-up magnetic force. As the developer bearer rotates, the developer reaches the regulation gap between the surface of the developer bearer and the developer regulator. At that time, the developer adjacent to the surface of the developer bearer can pass through the regulation gap, and the developer positioned away from the surface of the developer bearer is blocked by the developer regulator. Thus, with the regulation gap, the amount of developer transported to the development range can be adjusted. The developer removed by the developer regulator from the developer bearer is returned to the developer supply compartment and is again supplied to the developer bearer. Thus, the developer is circulated inside the development device.

The amount of developer transported to the regulation gap tends to fluctuate when the properties of the developer, such as fluidity, change due to the degradation of the developer over time or changes in the environment. In this case, the development ability becomes unstable. In view of the foregoing, for example, the magnetic field generator may be configured to have another magnetic pole to generate a magnetic force for causing the developer to stand on end on the developer bearer (hereinafter “regulation magnetic force”) when the developer passes through the regulation gap to alleviate the fluctuation in the amount of developer supplied to the development range.

### SUMMARY OF THE INVENTION

In view of the foregoing, one embodiment of the present invention provides a development device that includes a developer bearer to carry by rotation developer to a development range facing a latent image bearer, a development casing for containing developer, from which the developer bearer is exposed partly, a developer regulator disposed facing the developer bearer to adjust an amount of developer carried on the developer bearer, a supply compartment disposed adjacent to the developer bearer, a side wall disposed between the supply compartment and the developer bearer, a developer supply member to transport developer contained in the supply compartment in an axial direction of the developer bearer, and a channel forming member positioned adjacent to the side wall of the supply compartment. The channel forming member defines a supply route between the channel forming member and the side wall and a collecting route between the channel forming member and an inner wall of the development casing. In the axial direction, the supply compartment extends over the development range entirely. Through the supply route, developer is supplied from the supply compartment beyond the side wall to the developer bearer. Through the collecting route, developer blocked by the developer regulator is collected in the supply compartment. The side wall is monolithic with the development casing and constructed of a material identical with a material of the development casing. The channel forming member is constructed of a material having a degree of rigidity higher than that of the side wall, and end portions in the axial direction of the channel forming member are supported by the development casing.

In another embodiment, an image forming apparatus includes a latent image bearer, a latent image forming unit to form a latent image on the latent image bearer, and the above-described development device to develop the latent image formed on the latent image bearer.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of an image forming apparatus according to an embodiment of the present invention;

FIG. 2 is an end-on axial view of a development device included in the image forming apparatus shown in FIG. 1;

FIG. 3 is a cross-sectional view illustrating an axial end of the development device shown in FIG. 2;

FIG. 4 is a perspective view that illustrates a main portion of the axial end of the development device shown in FIG. 2;

FIG. 5 is an end-on axial view of a development device according to a comparative example, without a blocking member;

FIG. 6 is an end-on axial view of a development device according to another comparative example, with the blocking member; and

FIG. 7 is a perspective view illustrating a state in which the blocking member is removed from a partition in the development device shown in FIG. 6.

### DETAILED DESCRIPTION OF THE INVENTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

According to the embodiments of the present embodiment described below, a development device and an image forming apparatus in which installation of a channel forming member is easier, the support of the channel forming member is secured, and accuracy in the position of the channel forming member relative to a developer supply member and to a developer bearer can be secured.

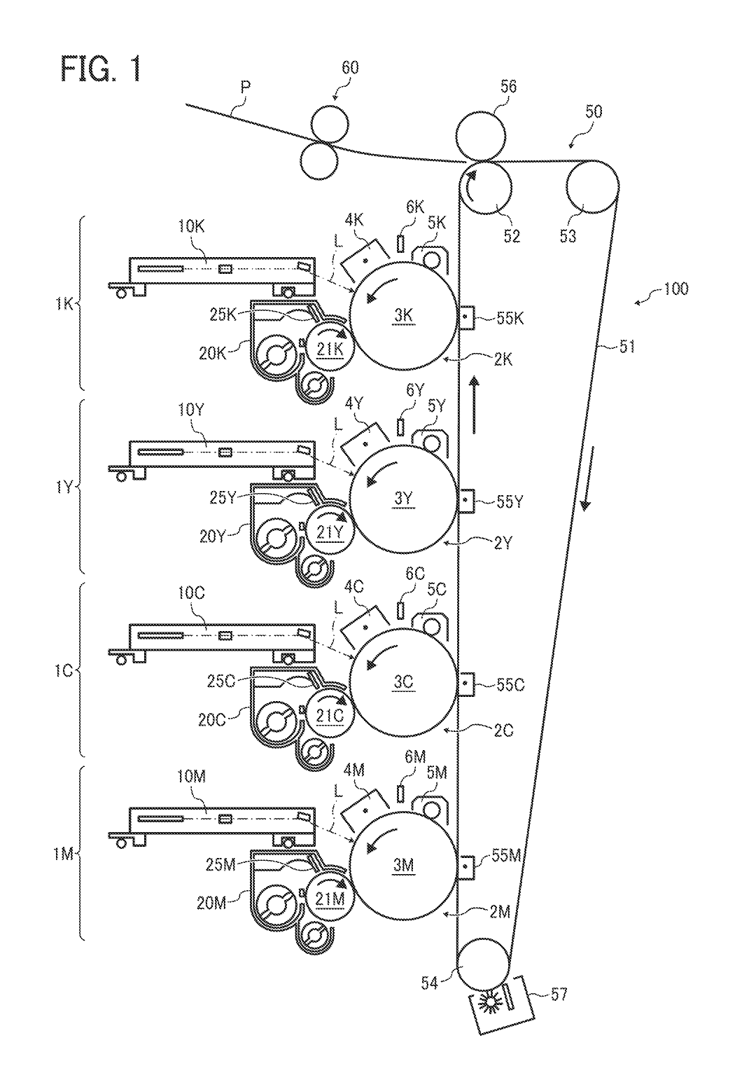

Referring now to the drawings, wherein like reference numerals designate identical or corresponding parts throughout the several views thereof, and particularly to FIG. 1, a multicolor image forming apparatus according to an embodiment of the present invention is described.

FIG. 1 is a schematic diagram of an image forming apparatus 100 according to the present embodiment that can be a multicolor laser printer, for example.

The image forming apparatus 100 includes four image forming stations 1M, 1C, 1Y, and 1K for forming magenta, cyan, yellow, and black toner images. The image forming stations 1M, 1C, 1Y, and 1K are arranged vertically in FIG. 1, and a transfer unit 50 is provided on a side thereof. The image forming stations 1M, 1C, 1Y, and 1K have a similar configuration except the color of toner used therein. Therefore, the image forming station 1M is described below as a representative, and descriptions of other image forming stations 1C, 1Y, and 1K are omitted.

The image forming station 1M includes a process unit 2M, an optical writing unit 10M, and a development device 20M.

The process unit 2M for magenta includes a drum-shaped photoreceptor 3M that rotates counterclockwise in FIG. 1, and, around the photoreceptor 3M, a charging unit 4M, a drum cleaning unit 5M, and a discharge lamp 6M are provided. These components are housed in a common unit casing as a single unit removably installable in the image forming apparatus 100.

For example, the photoreceptor 3M serving as a latent image bearer includes an aluminum base pipe and an organic photosensitive layer overlying it. The charging unit 4M uniformly charges a surface of the photoreceptor 3M that rotates counterclockwise in FIG. 1 to a negative polarity by corona charging.

The optical writing unit 10M includes a light source such as a laser diode, a polygon minor that is a regular hexahedron, a polygon motor to rotate the polygon minor, an f-θ lens, lenses, and reflection mirrors. The light source emits a laser beam L, being driven according to image data transmitted from, for example, computers. As the polygon mirror rotates, the laser beam L is reflected on the faces of the polygon minor, thus deflected, and reaches the photoreceptor 3M. While the surface of the photoreceptor 3M is thus scanned optically, an electrostatic latent image is formed thereon.

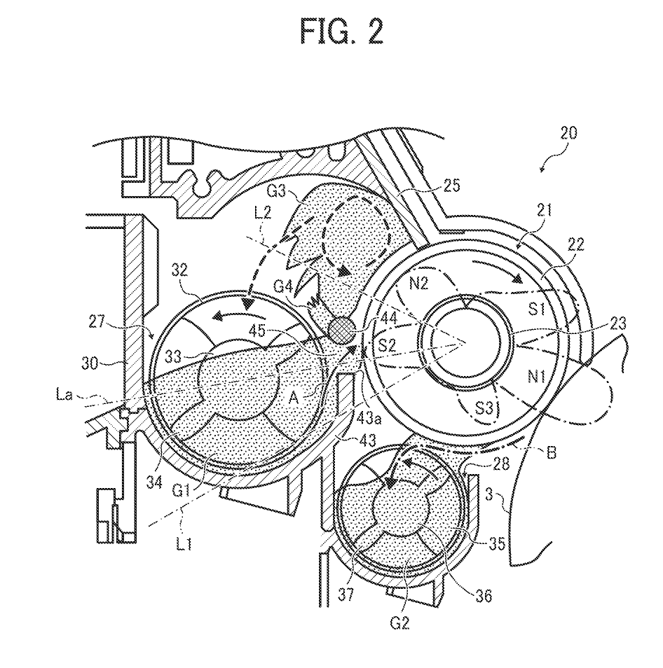

The development device 20M includes a casing 30 (i.e., a development casing) in which an opening is formed and a development roller 21M that is exposed partially through the opening. Referring to FIG. 2, the development roller 21M includes a development sleeve 22, serving as a developer bearer, and a magnet roller 23, serving as a magnetic field generator. The development sleeve 22 may be a nonmagnetic hollow cylinder and is rotatable driven by a driving unit. The magnet roller 23 is disposed inside the development sleeve 22 not to rotate as the development sleeve 22 rotates.

The casing 30 of the development device 20M contains magenta developer constituting essentially of magnetic carrier and magenta toner charged to a negative potential. The development device 20M further includes developer conveyance members, described below, to transport developer while agitating it to facilitate triboelectric charging thereof. Then, magenta toner is adsorbed on a surface of the rotating development sleeve 22 of the development roller 21M by the magnetic force exerted by the magnet roller 23. The amount of developer carried on the development sleeve 22 is adjusted by a doctor blade 25M as the rotating development sleeve 22 passes by the doctor blade 25M, after which developer is carried to a development range facing the photoreceptor 3M.

A power source applies a development bias of negative polarity to the development sleeve 22, and, in the development range, a development potential acts between the development sleeve 22 and the electrostatic latent image formed on the photoreceptor 3M to transfer the magenta toner having the negative polarity electrostatically from the development sleeve 22 to the latent image. By contrast, a non-development potential acts between the development sleeve 22 and the uniformly charged portions (background portion) of the photoreceptor 3M to transfer the magenta toner of negative polarity electrostatically from the photoreceptor 3M to the development sleeve 22.

Thus, magenta toner in magenta developer carried on the development sleeve 22 is transferred by the effects of the development potential to the electrostatic latent image on the photoreceptor 3M, and the electrostatic latent image is developed into a magenta toner image. After magenta toner therein is thus consumed, the magenta developer is returned from the development sleeve 22 into the casing 30 as the development sleeve 22 rotates. Referring to FIG. 1, the magenta toner image developed on the photoreceptor 3M is transferred onto an intermediate transfer belt 51 of the transfer unit 50.

The development device 20M further includes a toner concentration detector that in the present embodiment is a magnetic permeability sensor. The toner concentration detector outputs a voltage corresponding to the magnetic permeability of the magenta developer contained in a developer collecting compartment 28 (shown in FIG. 2), which is described later, provided in the development device 20M. Since the magnetic permeability of developer has a good correlation with the concentration of toner in the developer, the toner concentration detector outputs a voltage corresponding to the toner concentration. The value of the output voltage is transmitted to a toner supply controller.

The toner supply controller includes a storage unit such as a random access memory (RAM) and stores target values Vtref for the output voltages from the toner concentration detectors respectively provided in the development devices 20M, 20C, 20Y, and 20K in the storage unit. For supplying magenta toner, the toner supply controller compares the voltage output from the magenta toner concentration detector with the target value Vtref for magenta and drives a magenta toner supply device for a time period corresponding to the comparison result. With this operation, fresh magenta toner is supplied to the developer collecting compartment 28 in the development device 20M. By controlling the driving of the magenta toner supply device, toner is supplied as required to the magenta developer in which the toner concentration is decreased as the toner is consumed in image development, and the concentration of magenta toner in the magenta developer can be kept within a predetermined range. Similar toner supply control is performed in the development devices 20C, 20Y, and 20K.

After the transfer process, the drum cleaning unit 5M removes any toner remaining on the surface of the photoreceptor 3M. Subsequently, the discharge lamp 6M removes the electrical potential remaining on the photoreceptor 3M, after which the charging unit 4M charges the surface of the photoreceptor 3M uniformly.

It is to be noted that, although the image forming station 1M for magenta is described above, also in other image forming stations 1C, 1Y, and 1K, cyan, yellow, and black toner images are respectively formed on the photoreceptors 3C, 3Y, and 3K through similar processes.

The image forming stations 1M, 1C, 1Y, and 1K are arranged vertically in FIG. 1, and the transfer unit 50 is provided on the right thereof in FIG. 1. The transfer unit 50 further includes a driving roller 52, a tension roller 53, and a driven roller 54 disposed inside the loop of the endless intermediate transfer belt 51. The intermediate transfer belt 51 is stretched around the three rollers and is rotated clockwise ion FIG. 1 as the driving roller 52 rotates. A front side of a left portion of the intermediate transfer belt 51 extending vertically is in contact with the photoreceptors 3M, 3C, 3Y, and 3K, thus forming primary-transfer nips for magenta, cyan, yellow, and black therebetween.

Transfer chargers 55M, 55C, 55Y, and 55K are provided inside the loop of the intermediate transfer belt 51 in addition to the above-described three rollers. The transfer chargers 55M, 55C, 55Y, and 55K are positioned on the backsides of the respective primary-transfer nips and apply electrical charges to the back surface of the intermediate transfer belt 51. The electric charges thus applied to the intermediate transfer belt 51 generate transfer electric fields in the respective primary-transfer nips to transfer the toner electrostatically from the photoreceptors 3M, 3C, 3Y, and 3K to the front side of the intermediate transfer belt 51. It is to be noted that, instead of the corona charging transfer chargers, transfer rollers to which a transfer bias is applied may be used.

In the respective primary-transfer nips, the magenta, cyan, yellow, and black toner images are transferred primarily from the respective photoreceptors 3M, 3C, 3Y, and 3K and superimposed one on another on the front side of the intermediate transfer belt 51 due to the nip pressure and effects of the transfer electric field (primary transfer process). Thus, a superimposed multicolor (four colors in the present embodiment) toner image is formed on the intermediate transfer belt 51.

Additionally, a secondary-transfer bias roller 56 is provided in contact with the front side of a portion of the intermediate transfer belt 51 winding around the driving roller 52, thus forming a secondary-transfer nip therebetween. A voltage application unit that includes a power source and wiring applies a secondary-transfer bias to the secondary-transfer bias roller 56, and thus a secondary-transfer electric field is generated between the secondary-transfer bias roller 56 and the driving roller 52 that is grounded. The four-color toner image formed on the intermediate transfer belt 51 is transported to the secondary-transfer nip as the intermediate transfer belt 51 rotates.

Additionally, the image forming apparatus 100 includes a sheet tray for containing a bundle of recording sheets P. The recording sheets P contained in the sheet tray are fed to a paper feeding path from the top at a predetermined timing. A pair of registration rollers 60 pressing against each other is provided downstream from the sheet tray in a direction in which the recording sheet P is transported (hereinafter “sheet conveyance direction”), and the recording sheet P gets stuck in a nip between the registration rollers 60.

Although the pair of registration rollers 60 rotates to catch the recording sheet P in the nip, both rollers stop rotating immediately after catching a leading end of the recording sheet P. The recording sheet P is then transported to the secondary-transfer nip, timed to coincide with the four-color toner image formed on the intermediate transfer belt 51. In the secondary-transfer nip, the four-color toner image is transferred secondarily from the intermediate transfer belt 51 onto the recording sheet P at a time. Then, the four-color toner image becomes a full color toner image on the while recording sheet P. Subsequently, the recording sheet P carrying the multicolor toner image is transported to a fixing device, where the multicolor toner image is fixed on the recording sheet P.

A belt cleaning unit 57 is provided downstream from the secondary-transfer nip in the sheet conveyance direction and presses against the driven roller 54 via the intermediate transfer belt 51 to remove any toner remaining on the intermediate transfer belt 51 after the secondary transfer process.

It is to be noted that the suffixes M, C, Y, and K attached to each reference numeral indicate that components indicated thereby are used for forming magenta, cyan, yellow, and black images, respectively, and hereinafter may be omitted when color discrimination is not necessary.

FIG. 2 illustrates the development device 20 of the image forming station 1. In FIG. 2, a graph illustrating magnetic flux density in a direction normal to an outer circumferential surface of the magnet roller 23 is superimposed on an end-on axial view of the development device 20.

In FIG. 2, the drum-shaped photoreceptor 3 is positioned with its long axis (axial direction) perpendicular to the surface of the paper on which FIG. 2 is drawn. In the development device 20, a partition 43 divides an interior of the casing 30 into a developer supply compartment 27 and the developer collecting compartment 28 (hereinafter simply “supply compartment 27” and “collecting compartment 28”), in which developer is contained. In addition, a supply screw 32 and a collecting screw 35, serving as the developer conveyance members, are rotatably provided in the supply compartment 27 and the collecting compartment 28, respectively.

A rotary shaft of the development roller 21 is supported by front and rear walls of the casing 30 (proximal side and distal side in FIG. 2) so that the circumferential surface of the development sleeve 22 is partly exposed through the opening formed on the right side (facing the photoreceptor 3) of the casing 30. On the side opposite the photoreceptor 3, the development sleeve 22 faces the supply compartment 27 as well as the collecting compartment 28 over the substantially entire axial length of the development sleeve 22. The collecting compartment 28 is positioned beneath the development roller 21, and the supply compartment 27 is positioned on the side of the development roller 21, slightly lower than the development roller 21 in FIG. 2.

The supply screw 32 provided inside the supply compartment 27 is formed of a nonmagnetic material such as resin and extends horizontally similarly to the photoreceptor 3 and the development roller 21. The supply screw 32 includes a rotary shaft 33 and spiral-shaped screw blades 34 projecting from the circumferential surface of the rotary shaft 33. The rotary shaft 33 and the screw blades 34 integrally rotate counterclockwise in FIG. 2, driven by a driving unit including a motor and a drive transmission system.

The collecting screw 35 provided inside the collecting compartment 28 extends horizontally as well, similarly to the photoreceptor 3 and the development roller 21. The collecting screw 35 includes a rotary shaft 36 and spiral-shaped screw blades 37 formed of a nonmagnetic material such as resin, projecting from the circumferential surface of the rotary shaft 36. The rotary shaft 36 and the screw blades 37 integrally rotate counterclockwise in FIG. 2, driven by a driving unit.

Although partially separated by the partition 43, forming a side wall of the supply compartment 27 on the side of the development roller 21, the supply compartment 27 and the collecting compartment 28 can communicate with each other through openings formed in either end portion of the partition 43 in the axial direction of the development roller 21. A part of the casing 30 serves as the partition 43.

In the supply compartment 27, the developer carried inside the screw blade 34 of the supply screw 32 (hereinafter “developer G1”) is transported from the front to the back in the direction perpendicular to the surface of the paper on which FIG. 2 is drawn as the supply screw 32 rotates. While being transported, the developer G1 overstrides an upper end of the partition 43 and is supplied to the development sleeve 22 sequentially as indicated by arrow A shown in FIG. 2. The developer is then carried on the surface of the development sleeve 22 due to the magnetic force (i.e., pump-up magnetic force) exerted by the magnet roller 23 inside the development sleeve 22. The developer G1 that is not supplied to the development sleeve 22 but is transported to a downstream end portion of the supply compartment 27 (on the backside of the paper on which FIG. 2 is drawn) in the direction in which the developer is transported (hereinafter “developer conveyance direction”) therein falls to the collecting compartment 28 through the opening formed in the partition 43.

As the development sleeve 22 rotates, the developer carried thereon is transported to the development range and is used in image development. Subsequently, the developer is transported to a position facing the collecting compartment 28 as the development sleeve 22 rotates. Then, separated from the surface of the development sleeve 22 by a repulsive magnetic field generated by the magnet roller 23, the developer (hereinafter “developer G2”) falls to the collecting compartment 28 as indicated by broken arrow B shown in FIG. 2.

In the collecting compartment 28, the developer G2 carried inside the screw blades 37 of the collecting screw 35 is transported from the back side to the front side of the paper on which FIG. 2 is drawn as the collecting screw 35 rotates. While the developer is thus transported, the toner supply device supplies fresh toner to the collecting compartment 28. In addition, in an upstream end portion (on the back side of the paper on which FIG. 2 is drawn) of the collecting compartment 28 in the developer conveyance direction, the collecting compartment 28 receives the developer fallen from the supply compartment 27 through the opening in the partition 43. The developer is transported in the collecting compartment 28 by the collecting screw 35 to a downstream end portion in the developer conveyance direction and carried upward to the supply compartment 27 through the opening formed in the partition 43.

In the present embodiment, the magnet roller 23 includes five magnetic poles N1, S1, N2, S2, and S3 arranged in that order in the direction opposite the direction in which the development sleeve 22 rotates as shown in FIG. 2.

The magnetic poles N1 serves as a development pole to generate a development magnetic force for causing the developer carried on the development sleeve 22 to stand on end thereon. The magnetic pole S1 serves as a conveyance pole to generate a magnetic force for transporting the developer carried on the development sleeve 22 to the development range. The magnetic pole N2 serves as a regulation pole to generate a regulation magnetic force for causing the developer to stand on end on the development sleeve 22 when the developer passes through a regulation gap between the surface of the development sleeve 22 and the doctor blade 25 serving as a developer regulator. The magnetic pole S2 serves as a pump-up pole to generate a magnetic force for attracting or pumping up the developer onto the surface of the development sleeve 22. The magnetic pole S3 cooperates with the magnetic pole S2 to generate the repulsive magnetic field for separating the developer from the development sleeve 22 and collecting it in the collecting compartment 28.

In the above-described image forming apparatus 100 according to the present embodiment, the four photoreceptors 3M, 3C, 3Y, and 3K serve as the latent image bearers to carry the latent image on the respective surfaces that move as the photoreceptors 3M, 3C, 3Y, and 3K rotate. The optical writing units 10M, 10C, 10Y, and 10K serve as latent image forming units to form latent images on the respective photoreceptors 3 charged uniformly. Further, the development devices 20M, 20C, 20Y, and 20K develop the latent images formed on the photoreceptors 3M, 3C, 3Y, and 3K.

It is to be noted that, in FIG. 2, reference numeral 44 represents a blocking rod serving as a channel forming member, and 45 represents a slit formed between the blocking rod 44 and the partition 43. Further, reference character G3 represents developer blocked by the doctor blade 25 and retained by the regulation magnetic force, and G4 represents developer carried on the blocking rod 44.

It is to be noted that, in configurations in which the regulation pole for generating the regulation magnetic force is formed, the regulation magnetic force can also act on the developer blocked by the developer regulator, retaining such developer (hereinafter “retained developer”) in a portion downstream from the developer regulator in the direction of rotation of the developer bearer (hereinafter “retaining portion”).

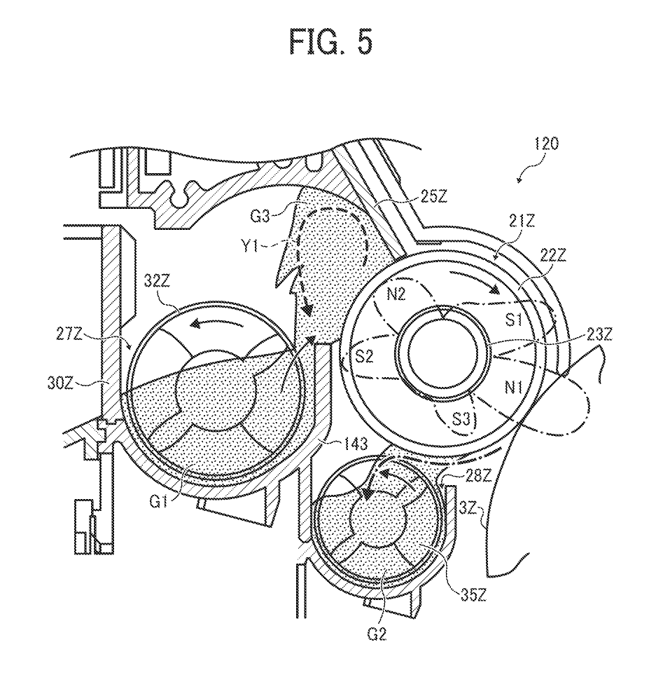

FIG. 5 illustrates a development device 120 as a first comparative example in which the configuration of a partition 143 is different from the partition 43 in the present embodiment. It is to be noted that components of the development device 120 similar to those of the development device 20 shown in FIG. 2 are given identical reference numerals as those shown in FIG. 2 with a suffix “Z”, and thus descriptions thereof are omitted.

In the comparative development device 120, the regulation magnetic force exerted by the regulation pole N2 acts on developer G3 prevented from passing through the regulation gap, and the regulation magnetic force retains the developer in the retaining portion adjacent to and upstream from a doctor blade 25Z in the direction of rotation of a development sleeve 22Z. As the development sleeve 22Z rotates, the developer G3 retained in the retaining portion (hereinafter “retained developer G3”) is circulated in the retaining portion in the direction opposite the direction of rotation of the development sleeve 22Z as indicated by broken arrow Y. It is possible that the retained developer G3 includes the developer G1 flipped up by a supply screw 32Z.

While retained by the regulation magnetic force and circulated in the retaining portion, the retained developer G3 is further electrically changed by sliding contact. As a result, the amount of charge of the toner (hereinafter “toner charge amount”) in the retained developer G3 is remarkably higher than that of the developer G1 in a supply compartment 27Z. This causes a difference in development ability between the retained developer G3 and the developer G1 in the supply compartment 27Z. Even if the development ability is different, visible unevenness in image density is not caused as long as the developer G1 and the retained developer G3 are dispersed uniformly and mixed. The unevenness in image density, however, becomes visible if mixing of the developers G1 and G3 are insufficient, degrading the image quality.

In the comparative development device 120, if the developer G3 being circulated escapes the restraint by the regulation magnetic force, the developer G3 is collected in the supply compartment 27Z and can be sufficiently mixed with the developer G1 before pumped up to the development sleeve 22Z again. Thus, the above-described degradation in image quality can be prevented. However, in FIG. 5, the pump-up pole S2 having the reverse polarity to that of the regulation pole N2 is positioned adjacent to and upstream from the regulation pole N2. This arrangement forms a magnetic field in which the magnetic force lines extending from the regulation pole N2 pass the retaining portion and are curved toward the pump-up pole S2. In such a magnetic field, a portion of the retained developer G3 closest to the pump-up pole S2 (close to the upper end of the partition 143) moves to the pump-up pole S2 along the magnetic force lines and then is attracted to the development sleeve 22Z. As a result, a part of the retained developer G3 is not collected in the supply compartment 27Z but is transported directly to the surface of the development sleeve 22Z.

At that time, if the amount of the developer G1 pumped up onto the development sleeve 22Z from the supply compartment 27Z is sufficient, the developer G3 attracted by the pump-up magnetic force overlays the developer G1. In this case, the developer G3 is positioned at the uppermost position, away from the surface of the development sleeve 22Z, and does not pass through the regulation gap, blocked by the doctor blade 25Z. Accordingly, the developer layer transported by the development range can contain the developer G1 only. Consequently, unevenness in image density and the degradation in image quality can be prevented or inhibited. However, in the comparative development device 120 shown in FIG. 5, the developer G3 attracted by the attraction magnetic force to the development sleeve 22Z hinders pumping up the developer G1 from the supply compartment 27Z.

In particular, in a portion where the force of blades of the supply screw 32Z conveying the developer G1 to the development sleeve 22Z is weaker (where outer circumferential portions of the screw blades 34Z do not pass by the development sleeve 22Z), the developer G1 supplied toward the development sleeve 22Z tends to be hindered by the developer G3 attracted by the pump-up magnetic force. As a result, in such a portion, it is possible that the retained developer G3 attracted by the pump-up magnetic force can be carried to an area adjacent to the surface of the development sleeve 22Z and transported through the regulation gap to the development range. Accordingly, in the developer layer conveyed to the development range, the developer G3 including the excessively charged toner and the developer G1 including the normally charged toner are not mixed sufficiently, which causes the unevenness in image density and the degradation in image quality.

In particular, in supply-collection separation type development devices, such as the comparative development device 120 shown in FIG. 5, the developer that has passed through the development range is collected in a collecting compartment 28Z different from the supply compartment 27Z. In such development devices, the developer G1 in the supply compartment 27Z is pumped up onto the development sleeve 22Z and transported to the downstream end portion in the developer conveyance direction. This means that the amount of the developer G1 flowing in the supply compartment 27Z decreases toward downstream in the developer conveyance direction, and it is more likely that the developer G1 supplied to the development sleeve 22Z is insufficient in the downstream end portion (hereinafter “local shortage of the developer G1”). Therefore, pumping up the developer G1 tends to be hindered in the downstream end portion of the supply compartment 27Z by the developer G3 attracted by the pump-up magnetic force, resulting in the unevenness in image density and degradation in image quality.

In view of the foregoing, in the present embodiment, a supply route through which developer moves from the supply compartment to the developer bearer can be secured, the retained developer G3 can be inhibited from moving to the developer bearer along the lines of regulation magnetic force, and a collecting route through which the retained developer G3 is collected in the supply compartment can be secured. More specifically, the channel forming member is provided to attain these effects.

With the channel forming member, the retained developer G3 attracted by the attraction magnetic force does not hinder pumping up the developer G1 from the supply compartment. Therefore, the local shortage of the developer G1 pumped up from the supply compartment can be prevented or restricted, and the developer G3 is less likely to pass through the regulation gap, being held in the portion adjacent to the surface of the development sleeve. Accordingly, the above-described developer layer in which the developer G3 including the excessively charged toner and the developer G1 including the normally charged toner are mixed insufficiently is not conveyed to the development range, thus restricting unevenness in the image density and the degradation of image quality.

For example, a through hole, serving as the supply route through which developer moves from the supply compartment to the developer bearer, may be formed in the partition between the supply compartment and the developer bearer, and the portion of the partition above the through hole may be used as the channel forming member.

Although this can be a convenient method to form the channel forming member, the channel forming member is subjected to an external force toward the developer bearer as developer moves through the supply route (i.e., the through hole) to the developer bearer. Additionally, the channel forming member further receives an external force toward the developer bearer as the retained developer G3 is attracted by the attraction magnetic force. Accordingly, there is a risk that the channel forming member is deformed toward the developer bearer by those external forces. In particular, the side wall of the supply compartment is typically monolithic with the development casing made of synthetic resin. Accordingly, the channel forming member is formed with the same synthetic resin as the development casing when produced through the above-described convenient method. Due to the high flexibility and deformability of synthetic resin, there is a risk that channel forming member made of synthetic resin deforms toward the developer bearer.

If the channel forming member deforms, the gap between the developer bearer and the channel forming member may become insufficient in size in the axial center area since the channel forming member is close to the developer bearer. In this state, compression force applied to developer passing through the gap, carried on the developer bearer, increases. Consequently, toner in the developer can coagulate or firmly adhere to the surface of the developer bearer, hindering proper image development. In particular, coagulated toner can adhere to the recording medium and appear as dots on the recording medium. Further, toner may be absent around coagulated toner, creating white voids.

Even if the above-described convenient method is used, deformation of the channel forming member may be inhibited by supporting the channel forming member in the axial center area in addition to the axial ends. Supporting the axial center area of the channel forming member by a rib monolithic with the development casing can be advantageous in that the rib, the channel forming member, and the development casing can be produced by monolithic molding at a relatively low cost. Such configurations, however, my cause streaky unevenness in image density at the position corresponding to the axial center area. From this aspect, the axial end areas are preferred to the axial center area as the positions where the channel forming member is supported.

To prevent streaky unevenness in image density, caused in the configuration in which the axial center area of the channel forming member is supported, the side wall of the supply compartment facing the developer bearer and the development casing may be formed by monolithic molding using an identical material, and the channel forming member may be formed separately using a material having a higher rigidity than that of the side wall so that the channel forming member is supported in only the axial end areas.

For example, tabs each shaped into a lateral “U” on cross section perpendicular to the axial direction of the developer bearer can be formed in the axial end areas of the channel forming member. The lateral U-shaped tabs project beyond the axial center area of the channel forming member toward the side wall of the supply compartment. The channel forming member is bonded to the side wall with the side wall fitted in the tabs so that the supply route from the supply compartment to the developer bearer can be secured between the side wall and the axial center area of the channel forming member. This configuration can prevent streaky unevenness in image density caused by the support of the channel forming member in the axial center area. Additionally, deformation of the channel forming member can be alleviated when the channel forming member is formed with a material having a higher rigidity than that of the side wall, separately from the development casing.

However, molding and assembling of the channel forming member are difficult in this configuration because the side wall is inserted in the tabs disposed in the axial end areas and then bonded thereto in the limited area between the supply compartment and the developer bearer. Additionally, it would be difficult to secure strength of the bonded portion between the channel forming member and the side wall and positional accuracy between the channel forming member and the developer conveyance member or that between the channel forming member and the developer bearer.

It is to be noted that, although the description above concerns a case in which the channel forming member is provided to secure the supply route through which developer moves from the supply compartment to the developer bearer and to inhibit the retained developer G3 from moving to the developer bearer, along the lines of the regulation magnetic force, the above-described inconvenience can occur in other configurations including such a channel forming member to secure the supply route between the channel forming member and the side wall of the supply compartment. Additionally, this inconvenience can occur in either two-component development devices or one-component development devices.

In view of the foregoing, the development device 20 according to the present embodiment is configured as follows.

As shown in FIG. 2, in the development device 20, the partition 43 is reduced in height with its upper end positioned lower compared with the comparative development device 120 shown in FIG. 5, and the columnar metal blocking rod 44 is provided as the channel forming member. Both axial ends of the blocking rod 44 are supported by the front and rear walls of the casing 30 that supports also the rotary shafts of the development roller 21 and the supply screw 32.

The blocking rod 44 is positioned to prevent the retained developer G3 from moving toward the development sleeve 22 along the magnetic force lines of the regulation magnetic force. More specifically, for example, a lower end of the blocking rod 44 (facing the slit 45 described below) is positioned upstream in the rotational direction of the development sleeve 22 from a straight line L2 (shown in FIG. 2) passing through a polarity change point between the attraction pole S2 and the regulation pole N2 and the center of rotation of the development sleeve 22.

The blocking rod 44 can prevent the retained developer G3 from hindering pumping up the developer G1 from the supply compartment 27 although the retained developer G3 can be attracted by the pump-up magnetic force. Therefore, local shortage of the developer G1 pumped up from the supply compartment 27 can be prevented or alleviated. Accordingly, it is less likely that the developer G3 attracted by the pump-up magnetic force passes through the regulation gap and is held in the portion adjacent to the surface of the development sleeve 22. Accordingly, the above-described developer layer in which the developer G3 including the excessively charged toner and the developer G1 including the normally charged toner is mixed insufficiently is not conveyed to the development range, thus restricting unevenness in the image density and the degradation of image quality.

In addition, in the present embodiment, as shown in FIG. 2, the shape and position of the blocking rod 44 as well as the configuration of the magnet roller 23 are designed so that the pump-up magnetic force can retain developer (hereinafter “developer G4”) on a surface of the blocking rod 44 facing the supply compartment 27. Then, the developer G4 can stand on end on the blocking rod 44 and form a wall to block the retained developer G3 moving to the slit 45, being attracted by the pump-up magnetic force. Thus, the retained developer G3 can be prevented effectively from passing through the slit 45. Accordingly, the above-described developer layer in which the developer G3 including the excessively charged toner and the developer G1 including the normally charged toner are mixed insufficiently is not conveyed to the development range, thus restricting unevenness in the image density and the degradation of image quality.

Additionally, the blocking rod 44 defines the slit 45 (i.e., the supply route) together with the upper end of the partition 43 for allowing the developer G1 to move from the supply compartment 27 toward the development sleeve 22. The slit 45 extends at least over the entire development range in the axial length of the development sleeve 22. Therefore, even in the configuration including the blocking rod 44, pumping up the developer G1 from the supply compartment 27 to the development sleeve 22 is not hindered.

In particular, in the present embodiment, when a straight line passing through a center of rotation of the development sleeve 22 as well as that of the supply screw 32 is referred to as “line La”, shown in FIG. 2, the slit 45 is positioned such that the line La also passes through the slit 45 as viewed in the axial direction of the development sleeve 22. This configuration can minimize the distance by which the developer G1 is transported from the supply compartment 27 to be supplied to the surface of the development sleeve 22.

Additionally, in the present embodiment, the blocking rod 44 is disposed to secure the collecting route between the blocking rod 44 and an upper wall (inner wall) of the casing 30 so that the retained developer G3, blocked by the doctor blade 25, can move to the supply compartment 27 through the collecting route. With this arrangement, the blocking rod 44 does not hinder the retained developer G3 from returning to the supply compartment 27.

The opening width of the slit 45, that is, the length in the rotational direction of the development sleeve 22, is preferably 2 mm or greater. If the opening width of the slit 45 is shorter than 2 mm, it is difficult for the developer G1 to move through the slit 45 smoothly when the carrier particles have a volume average particle size of about 50 μm. If the developer G1 does not move through the slit 45 smoothly, the amount of developer G1 supplied to the development sleeve 22 can be insufficient, and the retained developer G3 can be held in the portion where the amount of the developer G1 is insufficient and transported through the regulation gap to the development range. As a result, the image density can become uneven, degrading the image quality.

By contrast, the slit 45 having an opening width of 2 mm or greater can secure smooth passage of the developer G1 through the slit 45 even when carrier particles have a volume average particle size of about 50 μm. In particular, the reduction in the particle diameter of carrier particles has progressed recently. Use of developer including small diameter carrier particles can ensure smooth passage of the developer G1 through the slit 45, and the image density can be kept uniform, preventing degradation in the image quality.

Further, fluctuations in the amount of developer supplied to the development range can affect the development ability significantly. Therefore, the regulation gap between the doctor blade 25 and the surface of the development sleeve 22 is designed to ensure that the predetermined amount of developer is supplied reliably to the development range. If a shielding gap, meaning a distance between the surface of the development sleeve 22 and a portion of the blocking rod 44 closest to the development sleeve 22, is smaller than the regulation gap, the amount of developer carried on the development sleeve 22 and transported through the shielding gap is reduced from the amount of developer transported through the regulation gap. In such a case, even if the developer transported through the shielding gap does not include the retained developer G3, the developer layer that passes through the regulation gap can include the retained developer G3 overlying the developer G1. If the retained developer G3 is dispersed uniformly in the developer layer that passes through the regulation gap, a uniform image density can be maintained, keeping a satisfactory image quality, even in this case. However, image density can become improper when the ratio of the retained developer G3 having excessively charged toner particles is higher in the developer layer that contributes to image development in the development range.

In view of the foregoing, in the present embodiment, the shielding gap between the blocking rod 44 and the surface of the development sleeve 22 is not smaller than the regulation gap in a portion where the blocking rod 44 is closest to the surface of the development sleeve 22. With this configuration, the developer layer that has passed through the shielding gap can pass through the regulation gap as is. That is, in the developer layer that passes through the regulation gap, the retained developer G3 is not mixed in the developer G1 pumped up from the supply compartment 27, having normally charged toner particles. Therefore, the unevenness in the image density can be resolved or restricted.

Additionally, the height of the partition 43 in the present embodiment is reduced from that in the comparative development device 120 shown in FIG. 5. In the comparative development device 120, when the amount of the developer G1 present in the supply compartment 27 is small, shortage of developer supplied to the development sleeve 22Z can arise. By contrast, even when the amount of the developer G1 is small, the shortage of the supplied toner can be prevented in the present embodiment, owing to the reduced height of the partition 43. Accordingly, even in the downstream end portion of the supply compartment 27 in the developer conveyance direction, the above-described developer layer in which the developer G3 including the excessively charged toner and the developer G1 including the normally charged toner are mixed insufficiently is not conveyed to the development range, thus restricting unevenness in the image density and the degradation of image quality.

The pump-up magnetic force, however, might fail to catch the developer G1 that has overstridden the upper end of the partition 43, letting the developer to fall, if the height of the partition 43 is excessively low. If the developer G1 thus drops, the amount of the developer supplied from the supply compartment 27 to the development sleeve 22 becomes insufficient, allowing the retained developer G3 pumped up by the pump-up magnetic force to go around the lower end of the blocking rod 44. As a result, it is possible that the retained developer G3 is carried in a portion closer to the surface of the development sleeve 22 that can pass through the regulation gap.

In view of the foregoing, in the present embodiment, the partition 43 and the magnet roller 23 are configured so that, when a single magnetic carrier particle is disposed at an edge 43a of the partition 43, which faces the development sleeve 22, in a state in which no developer is present in the development device 20, the resultant of magnetic force and the gravity acting on the magnetic carrier particle positioned at the edge 43a is horizontal or inclined upward.

Further, if the height of the partition 43 is excessively low, it is possible that the used developer G2, separated from the surface of the development sleeve 22 by the repulsive magnetic field, can overstride the partition 43 and reach the supply compartment 27. Since the toner contained in the developer is consumed in the development range, the concentration of toner in the used developer G2 is reduced. If the used developer G2 moves to the supply compartment 27 and is supplied to the development sleeve 22, the developer G1 having a standard toner concentration, pumped up from the supply compartment 27, and the developer G2 having a reduced toner concentration, which are not mixed sufficiently, can pass through the regulation gap and be used in image development. In this case, image density can become uneven, degrading image quality. Thus, the partition 43 should have a height sufficient for preventing the used developer G2 from moving to the supply compartment 27. Therefore, the upper end of the partition 43 is positioned downstream in the rotational direction of the development sleeve 22 from a release portion where the releasing magnetic force for separating the used developer G2 from the development sleeve 22 acts. More specifically, for example, the upper end of the partition 43 is positioned downstream in the rotational direction of the development sleeve 22 from a straight line L1 (shown in FIG. 2) passing through a polarity change point between the attraction pole S2 and the magnetic pole S3 and the center of rotation of the development sleeve 22.

Additionally, in the development device 20 according to the present embodiment, the long blocking rod 44 is supported in the longitudinal end areas by the front and rear walls of the casing 30, but the casing 30 (or the partition 43) does not have a support for the blocking rod 44 in the axial center area. This arrangement is aimed at inhibiting streaky image density unevenness, which can arise when a support of the blocking rod 44 is present in the axial center area.

It is to be noted that, to enable image development of A4 size, the length of the development range in the axial direction or longitudinal direction of the development device 20 (hereinafter “development range width”) is preferably 300 mm or greater. More preferably, the development range width is 320 mm or greater to secure a peripheral margin on a typical sheet size having a width of 330 mm (substantially equivalent to 13 inches). Accordingly, it is preferred that the slit 45 have a width of 320 mm or greater, whereas the blocking rod 44 has a diameter of about 3 mm in the present embodiment.

As described above, as developer moves through the slit 45, the external force toward the development sleeve 22 is applied to the blocking rod 44. The blocking rod 44 further receives the force toward the development sleeve 22 from the retained developer G3 being attracted by the attraction magnetic force. Accordingly, it is possible that the blocking rod 44 deforms heavily if the blocking rod 44 is produced by monolithic molding with the casing 30 using an identical material, such as synthetic resin having a high degree of flexibility, similarly to the partition 43 for cost reduction or the like. As a result, the shielding gap between the development sleeve 22 and the blocking rod 44 can be narrowed in the axial center area.

Then, the amount of developer carried on the development sleeve 22 becomes insufficient in the axial center area, and the shortage is compensated by the retained developer G3 in the retaining portion. In this case, in the axial center area, a large amount of retained developer G3 can be transported to the development range, causing image density unevenness and degrading image quality. Additionally, in the portion where the shielding gap is reduced, compression force given to the developer passing therethrough increases. As a result, toner in developer can coagulate and stick to the surface of the development sleeve 22, thus hindering image development. In particular, coagulated toner can adhere to the recording medium and appear as dots thereon, and toner may be absent around coagulated toner, creating white voids. Thus, image quality is degraded.

In view of the foregoing, it is preferred that the blocking rod 44 be formed with a metal material having a degree of rigidity greater than that of resin used for the partition 43 monolithic with the casing 30. Although it is difficult to attain high rigidity at a relatively low cost using the same synthetic resin as that used for the casing 30, metal can attain high rigidity more easily.

As the material for the blocking rod 44, Steel Use Stainless (SUS) 304 and SUS 316 according to Japan Industrial Standard (JIS) are preferable. In addition to stainless steel, nonmagnetic metal having high rigidity, such as titanium or magnesium, may be used although the cost increases. The blocking rod 44 may be formed with aluminum that is less expensive although aluminum is less rigid than stainless steel.

In the present embodiment, the blocking rod 44 is formed with SUS 304 and processed to have infinitesimal magnetism. Although the blocking rod 44 made of magnetic steel material may hinder flow of developer through the slit 45, such an inconvenience does not occur if the magnetism is in trace amounts. More specifically, if the material of the blocking rod 44 is magnetic, developer adheres to the blocking rod 44 magnetically. Thus, movement of developer through the slit 45 is inhibited. As a result, the amount of the developer G1 pumped up from the supply compartment 27 can be insufficient, and the retained developer G3 can contribute to image development. Further, developer moving through the slit 45 can slidingly contact the developer adhering to the blocking rod 44, and toner can be separated from the developer, resulting in coagulation of toner. Such inconveniences can be inhibited when the material of the blocking rod 44 is nonmagnetic. Accordingly, shortage of the developer G1 pumped up from the supply compartment 27 as well as contribution of the retained developer G3 to image development can be inhibited.

A development device according to a comparative example that employs a metal stay as the channel forming member is described below.

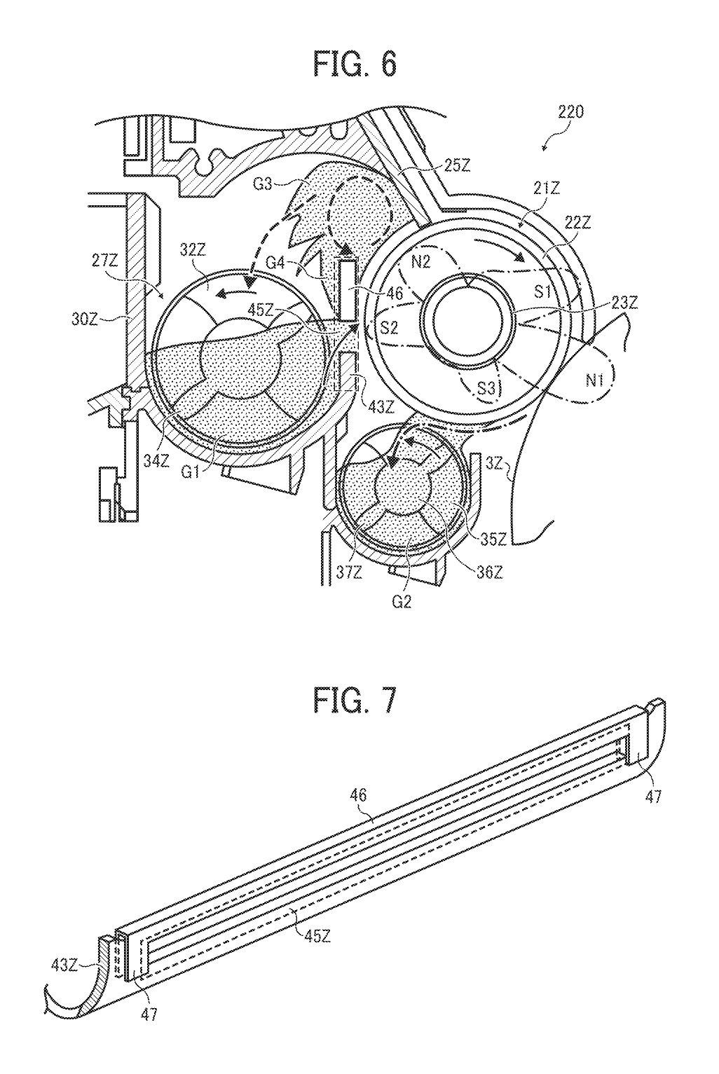

FIG. 6 illustrates a comparative development device 220, and FIG. 7 is a perspective view illustrating a state in which the metal stay is removed from a partition of the development device 220 shown in FIG. 6. It is to be noted that components of the development device 220 similar to those of the development device 20 shown in FIG. 2 are given identical reference numerals with a suffix “Z”, and thus descriptions thereof are omitted.

In the development device 220 shown in FIG. 6, a metal stay 46 includes tabs 47 positioned in end areas in the axial direction of a development sleeve 22Z, and the metal stay 46 is attached with the tabs 47 to a partition 43Z that is a part of a casing 30Z. The tabs 47 are positioned outside the development range in the axial direction and extend to the partition 43Z beyond the axial center area of the metal stay 46. Each tab 47 is lateral U-shaped in cross section perpendicular to the axial direction. In assembling of the metal stay 46 to the partition 43Z, the partition 43Z is inserted in the openings of the lateral U-shaped tabs 47 of the metal stay 46, and the metal stay 46 is glued to the partition 43Z. Alternatively, the metal stay 46 may be mechanically engaged with the partition 43Z.

In the development device 220, however, it is not easy to insert the partition 43Z in the tabs 47 positioned in the axial end areas of the metal stay 46 and bond the metal stay 46 to the partition 43Z in a limited space between a development roller 21Z and a supply screw 32Z. Accordingly, it is difficult to secure the strength of the bonded portion between the metal stay 46 and the partition 43Z and positional accuracy between the development roller 21Z and the metal stay 46 and that between the supply screw 32Z and the metal stay 46.

In view of the foregoing, in the present embodiment, the blocking rod 44 serving as the channel forming member is fixed to the casing 30.

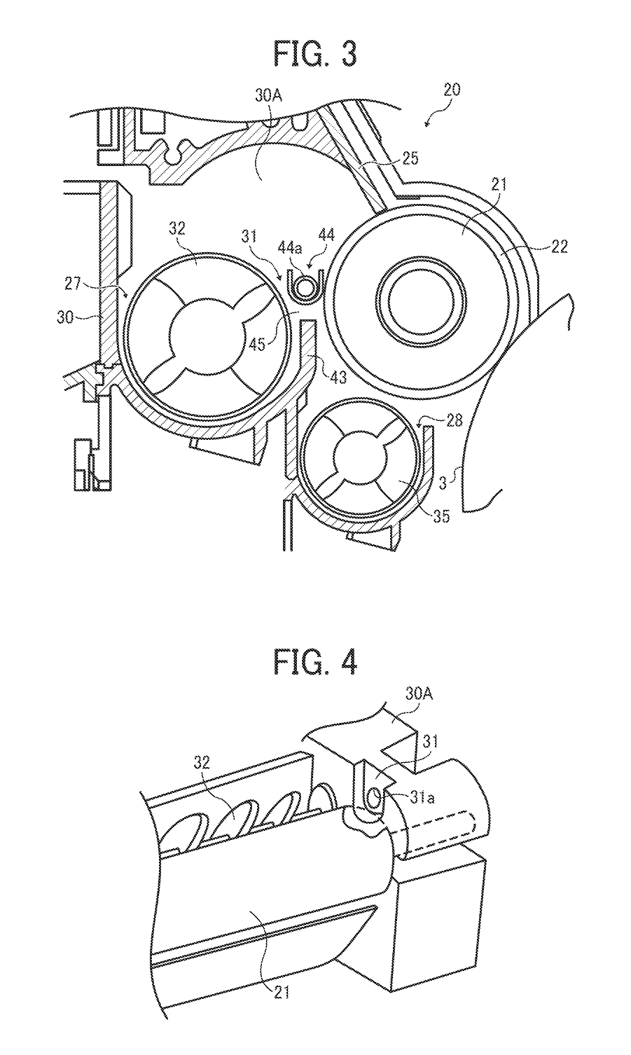

FIG. 3 is a cross-sectional view illustrating an axial end of the development device 20 according to the present embodiment. It is to be noted that reference character 30A shown in FIG. 3 represents the rear wall of the casing 30. FIG. 4 is a perspective view illustrating a main part of the axial end of the development device 20.

Referring to FIGS. 3 and 4, the blocking rod 44 can be attached to the front wall and rear wall 30A of the casing 30 in a sufficient space, compared with the comparative example shown in FIG. 6 in which the metal stay 46 is attached to the partition 43Z. This configuration can improve efficiency in assembling, and the blocking rod 44 can be supported by the casing 30 more securely and easily. Additionally, the axial end portions of the development roller 21 are supported via bearings by the front wall and rear wall 30A of the casing 30. Since the blocking rod 44 and the development roller 21 are thus supported by the identical components, a high positional accuracy can be attained easily between the blocking rod 44 and the development roller 21. Additionally, the axial end portions of the supply screw 32 are supported via bearings by the front wall and rear wall 30A of the casing 30. Since the blocking rod 44 and the supply screw 32 are thus supported by the identical components, a high positional accuracy can be attained easily between the blocking rod 44 and the supply screw 32.

As shown in FIGS. 3 and 4, for example, a U-shaped recess 31 for receiving the blocking rod 44 can be formed on the rear wall 30A of the casing 30. Although not shown, the recess 31 can be formed also on the front wall of the casing 30. Thus, the blocking rod 44 can be easily fixed to the casing 30, being fitted in the recesses 31. It is to be noted that the guide for the channel forming member (i.e., the blocking member 44) is not limited to the U-shaped recess 31 shown in FIG. 3 but may be, for example, V-shaped or rectangular in conformity with the shape of the channel forming member.

Additionally, it is preferable that the blocking rod 44 be screwed to the casing 30 in the development device 20 according to the present embodiment. In the configuration shown in FIGS. 3 and 4, a screw hole 44a is formed in either axial end of the columnar blocking rod 44 so that a screw having spiral projection can be fitted in the screw hole 44a. As shown in FIG. 4, in the recess 31 of the casing 30, a hole 31a through which the screw is insertable is formed. With this configuration, the blocking rod 44 is screwed to the front and rear sides of the casing 30 with the casing 30 interposed between the screw and the end of the blocking rod 44. Since the blocking rod 44 is screwed to the front and rear sides of the casing 30, the blocking rod 44 can be disposed at a proper position easily.

Additionally, the axial length of the blocking rod 44 is preferably shorter than the distance between the front wall and the rear wall 30A at the position where the blocking rod 44 is attached, that is, the axial length of the space to accommodate the blocking rod 44. With this configuration, the blocking rod 44 can be tensed by screw clamp, making the blocking rod 44 stronger against deformation or vibration. Thus, the high positioning accuracy of the blocking rod 44 can be maintained. This configuration is advantageous also in keeping the shape of the slit 45 defined by the blocking rod 44 and the partition 43.

Although, in the present embodiment, the blocking rod 44 serving as the channel forming member is columnar and has screw holes at the axial ends, the shape of the channel forming member is not limited thereto. For example, the channel forming member may be planar and bent in molding as shown in FIG. 7. The columnar blocking rod 44 made of metal according to the present embodiment is advantageous in that sufficient rigidity can be attained easily and processing, such as formation of screw holes, is easy.

The various configurations according to the present inventions can attain specific effects as follows.

Configuration A: A development device includes a developer bearer, such as the development sleeve 22, to carry by rotation developer to a development range facing a surface of a latent image bearer such as the photoreceptor 3, a development casing, such as the casing 30, for containing the developer bearer, having an opening through the developer bearer is exposed partly and faces the surface of the latent image bearer, a developer regulator, such as the doctor blade 25, to form a regulation gap together with the surface of the developer bearer to adjust an amount of developer carried by the developer bearer to the development range, and a supply compartment, such as the supply compartment 27, disposed adjacent to the developer bearer, through which developer supplied to the surface of the developer bearer is transported in an axial direction of the developer bearer by a developer supply member, such as the supply screw 32. In the development device, a side wall, such as the partition 43, defines a side of the supply compartment adjacent to the developer bearer, and developer is supplied from the supply compartment beyond the side wall to the developer bearer. Further, a channel forming member, such as the blocking rod 44, is provided to form a supply route between the channel forming member and the side wall to allow developer to flow from the supply compartment to the developer bearer at least over the entire development range in the axial direction and to form a collecting route between the channel forming member and an inner wall of the development casing to collect developer blocked by the developer regulator into the supply compartment. Further, the side wall of the supply compartment is monolithic with the development casing and constructed of a material identical with a material of the development casing, the channel forming member is constructed of a material having a degree of rigidity higher than that of the side wall, and end portions in the axial direction of the channel forming member are supported by the development casing.

As described above, since the channel forming member is configured to be supported by the development casing at the axial ends thereof in this configuration, the channel forming member can be attached to the development casing using a sufficient space in the axial direction of the developer bearer. This configuration can improve efficiency in installation of the channel forming member, and the channel forming member can be supported by the development casing securely and easily.

Additionally, since an identical component (i.e., the casing 30) supports the axial end portions of the developer bearer (via bearings) and the channel forming member, a high positional accuracy can be attained easily between the channel forming member and the developer bearer. Similarly, since an identical component (i.e., the casing 30) supports the axial end portions of the developer supply member (via bearings) and the channel forming member, a high positional accuracy can be attained easily between the channel forming member and the developer supply member.

Configuration B: In configuration A, the channel forming member is made of metal.

Accordingly, the channel forming member having a relatively high rigidity can be formed easily as described above.

Configuration C: In configuration A or B, two-component developer including toner and magnetic carrier is used, a magnetic field generator is provided inside the developer bearer to generate magnetic force for carrying developer on the surface of the developer bearer, and the channel forming member is formed with a nonmagnetic material. This configuration can inhibit magnetic adhesion of developer to the channel forming member and hindrance to passage of developer through the supply route as described above. That is, shortage of the developer pumped up from the supply compartment as well as contribution of the retained developer to image development can be inhibited.

Configuration D: In any of configurations A, B, and C, a guide, such as the recess 31, is formed in the development casing for guiding and supporting the channel forming member. With this configuration, the channel forming member can be installed at a desired position easily to secure the positional accuracy relative to the developer bearer and the developer supply member.

Configuration E: In any of configurations A through D, the channel forming member is tensed as the channel forming member is engaged with and supported by the development casing.

With this configuration, the tensed channel forming member can be stronger against deformation or vibration, and high positioning accuracy thereof can be maintained.

Configuration F: In any of configurations A through E, the channel forming member is substantially cylindrical, and a screw hole, such as the screw hole 44a, is formed in the engaged portion at the end thereof in the direction of rotary shaft of the developer bearer.

In this configuration, the substantially cylindrical channel forming member can make it easier to attain sufficient rigidity and processing, such as formation of screw holes. Thus, the cost of the channel forming member can be relatively low.

Configuration G: In an image forming apparatus that includes a latent image bearer such as the photoreceptor 3, a latent image forming unit, such as the optical writing unit 10, to form a latent image on the latent image bearer, and a development device, such as the development device 20, to develop, with two-component developer including toner and carrier, the latent image formed on the latent image bearer, the development device according to any of the above-described configurations A through F is used.

This configuration enables production of high-quality images with image density unevenness inhibited.

Numerous additional modifications and variations are possible in light of the above teachings. It is therefore to be understood that, within the scope of the appended claims, the disclosure of this patent specification may be practiced otherwise than as specifically described herein.

What is claimed is:

1. A development device comprising:
a developer bearer to carry by rotation developer to a development range, the developer bearer exposed partly from a development casing;
a developer regulator disposed facing the developer bearer to adjust an amount of developer carried on the developer bearer;
a supply compartment formed inside the development casing, adjacent to the developer bearer, the supply compartment including a side wall on a side of the developer bearer, the side wall monolithic with the development casing and constructed of a material identical with a material of the development casing;
a developer supply member to transport developer contained in the supply compartment in an axial direction of the developer bearer; and
a channel forming member extending in the axial direction, constructed of a material having a degree of rigidity higher than that of the side wall,
the channel forming member defining, with the side wall, a supply route through which developer moves from the supply compartment beyond the side wall to the developer bearer, the supply route extending at least over an entire development range in the axial direction,
the channel forming member defining, with an inner wall of the development casing, a collecting route through which developer blocked by the developer regulator is collected in the supply compartment,
wherein both end portions of the channel forming member in the axial direction are supported by the development casing.

2. The development device according to claim 1, wherein the channel forming member is constructed with a metal material.

3. The development device according to claim 1, further comprising a magnetic field generator positioned inside the developer bearer to generate magnetic force for carrying developer on the surface of the developer bearer,
wherein the developer comprises toner and magnetic carrier, and
the channel forming member is constructed with a nonmagnetic material.

4. The development device according to claim 1, wherein the development casing comprises a guide for guiding and supporting the channel forming member.

5. The development device according to claim 1, wherein the channel forming member is tensed by engagement with the development casing.

6. The development device according to claim 5, wherein the channel forming member is substantially cylindrical, a screw hole is formed in either end portion thereof in the axial direction, and the both end portions of the channel forming member are screwed to the development casing.

7. The development device according to claim 5, wherein the each end portion of the channel forming member in the axial direction is supported by a face of the development casing perpendicular to the axial direction.

8. An image forming apparatus comprising:
a latent image bearer;
a latent image forming unit to form a latent image on the latent image bearer; and
the development device according to claim 1, to develop the latent image formed on the latent image bearer.
